(19) United States
(12) Patent Application Publication
(10) Pub. No.: US 2024/0079002 A1
(43) Pub. Date: Mar. 7, 2024

(54) MINUTES OF MEETING PROCESSING METHOD AND APPARATUS, DEVICE, AND MEDIUM

(71) Applicant: BEIJING ZITIAO NETWORK TECHNOLOGY CO., LTD., Beijing (CN)

(72) Inventors: Chunsai DU, Beijing (CN); Jingsheng YANG, Beijing (CN); Kojung CHEN, Beijing (CN); Xiang ZHENG, Beijing (CN); Wenming XU, Beijing (CN)

(21) Appl. No.: 18/262,400

(22) PCT Filed: Jan. 5, 2022
(86) PCT No.: PCT/CN2022/070282

§ 371 Date: Jul. 21, 2023

(30) Foreign Application Priority Data
Jan. 27, 2021 (CN) 202110113700.1

(51) Int. Cl. G10L 15/19; G06F 3/16; G06Q 10/10; G10L 15/04; G10L 15/06; G10L 15/22

(52) U.S. Cl. CPC G10L 15/19; G06F 3/165; G06Q 10/10; G10L 15/04; G10L 15/063; G10L 15/22

(57) ABSTRACT

A minutes of meeting processing method, a device, and a medium. The method comprises: acquiring meeting text of a meeting audio/video; inputting the meeting text into a to-do identification model, and determining initial to-do statements; inputting the initial to-do statements into a tense determination model, and determining tense results of the initial to-do statements; and determining a meeting to-do statement in the initial to-do statements on the basis of the tense results.

This application is the national phase of International Patent Application No. PCT/CN2022/070282 filed on Jan. 5, 2022, which claims the priority to Chinese Patent Application No. 202110113700.1 titled “MINUTES OF MEETING PROCESSING METHOD AND APPARATUS, DEVICE, AND MEDIUM”, filed on Jan. 27, 2021 with the China National Intellectual Property Administration (CNIPA), both of which are incorporated herein by reference in their entireties.

### FIELD

The present disclosure relates to the technical field of meeting recognition, and in particular, to a method and an apparatus for processing meeting minutes, a device and a medium.

### BACKGROUND

With the continuous development of intelligent devices and multimedia technology, online meetings by means of the intelligent devices are increasingly used in daily and office life, because of outstanding performance in communication efficiency and information retention.

The meeting audio and meeting video may be converted into text through recognition processing, and to-do statement(s) including task intention may be determined from the text. However, there is a problem of low efficiency and low accuracy in determining the to-do statement.

### SUMMARY

In order to solve the above technical problems or at least partially solve the above technical problems, a method and an apparatus for processing meeting minutes, a device and a medium are provided according to the present disclosure.

A method for processing meeting minutes is provided according to an embodiment of the present disclosure. The method includes:
acquiring a meeting text of a meeting audio-video;
inputting the meeting text into a to-do recognition model to determine initial to-do statements;
inputting the initial to-do statements into a tense determination model to determine a tense result of each of the initial to-do statements; and
determining a meeting to-do statement from the initial to-do statements based on the tense results.

A method for processing meeting minutes is further provided according to an embodiment of the present disclosure. The method includes:
receiving a display triggering operation performed by a user on a target minutes statement in meeting minutes display interface, where the meeting minutes display interface displays a meeting audio-video, meeting text of the meeting audio-video, and the target minutes statement; and
displaying the target minutes statement and a statement associated with the target minutes statement.

An apparatus for processing meeting minutes is further provided according to an embodiment of the present disclosure. The apparatus includes:
a text acquiring module, configured to acquire a meeting text of a meeting audio-video;
an initial to-do module, configured to input the meeting text into a to-do recognition model to determine initial to-do statements;
a tense determining module, configured to input the initial to-do statements into a tense determination model to determine a tense result of each of the initial to-do statements; and
a meeting to-do module, configured to determine a meeting to-do statement from the initial to-do statements based on the tense results.

An apparatus for processing meeting minutes is further provided according to an embodiment of the present disclosure. The apparatus includes:
a display triggering module, configured to receive a display triggering operation performed by a user on a target minutes statement in meeting minutes display interface, where the meeting minutes display interface displays a meeting audio-video, meeting text of the meeting audio-video, and the target minutes statement; and
a displaying module, configured to display the target minutes statement and a statement associated with the target minutes statement.

An electronic device is further provided according to an embodiment of the present disclosure. The electronic device includes: a processor and a memory. The memory is configured to store executable instructions of the processor. The processor is configured to read the executable instructions from the memory and execute the instructions to perform the method for processing meeting minutes according to the embodiments of the present disclosure.

A computer-readable storage medium is further provided according to an embodiment of the present disclosure. The storage medium stores a computer program, and the computer program is used to perform the method for processing meeting minutes according to the embodiments of the present disclosure.

Compared with the conventional technology, the technical solution according to the embodiment of the present disclosure has the following advantages. In the solutions for processing meeting minutes according to the embodiments of the present disclosure, a meeting text of a meeting audio-video is acquired; the meeting text is inputted into a to-do recognition model to determine initial to-do statements; the initial to-do statements are inputted into a tense determination model to determine a tense result of each of the initial to-do statements; and a meeting to-do statement is determined from the initial to-do statements based on the tense results. According to the above technical solutions, tense determination is additionally perform on the basis of recognizing the initial to-do statements in the meeting text of the meeting audio-video, avoiding to identify a statement of already fulfilled task as the meeting to-do statement, greatly improving the accuracy of determining the meeting to-do statement, thereby improving the work efficiency of the user based on the meeting to-do statement, and improving the experience effect of the user.

### BRIEF DESCRIPTION OF THE DRAWINGS

The above and other features, advantages and aspects of embodiments of the present disclosure become clear with reference to the following embodiments in conjunction with drawings. Throughout all the drawings, the same or similar reference numerals indicate the same or similar elements. It should be understood that the drawings are schematic and the component and elements are not necessarily drawn to scale.

FIG. 1 is a schematic flow chart of a method for processing meeting minutes according to an embodiment of the present disclosure;

FIG. 2 is a schematic flow chart of a method for processing meeting minutes according to another embodiment of the present disclosure;

FIG. 3 is a schematic diagram of meeting minutes display interface according to an embodiment of the present disclosure;

FIG. 4 is a schematic structural diagram of an apparatus for processing meeting minutes according to an embodiment of the present disclosure;

FIG. 5 is a schematic structural diagram of an apparatus for processing meeting minutes according to an embodiment of the present disclosure; and

FIG. 6 is a schematic structural diagram of an electronic device according to an embodiment of the present disclosure.

### DETAILED DESCRIPTION

Embodiments of the present disclosure are described in detail below with reference to the drawings. Although some embodiments of the present disclosure are shown in the drawings, it should be understood that the present disclosure may be implemented in various forms and should not be limited to the embodiments set forth herein. In addition, the embodiments are provided for more thoroughly and completely understanding the present disclosure. It should be understood that the drawings and embodiments of the present disclosure are merely exemplary, rather than to limit the protection scope of the present disclosure.

It should be understood that the steps in the method embodiments of the present disclosure may be performed in different orders and/or in parallel. In addition, the method embodiments may include additional steps and/or some illustrated steps may be omitted. The scope of the present disclosure is not limited in this aspect.

The term “including” and variants thereof in the present disclosure are openness including, that is, “including but not limited to”. The term “based on” is “based at least in part on”. The term “one embodiment” indicates “at least one embodiment”. The term “another embodiment” indicates “at least one other embodiment”. The term “some embodiments” indicates “at least some embodiments”. Relevant definitions of other terms are given in the following description.

It should be noted that wordings of “first” and “second” described in the present disclosure are only used to distinguish different devices, modules or units, and are not used to limit the order or interdependence of functions performed by the devices, modules or units.

It should be noted that wordings of “one” and “multiple” described in the present disclosure are schematic rather than restrictive, and those skilled in the art should understand the “one” and “multiple” as “one or more” unless otherwise clearly indicated in the context.

Names of messages or information exchanged among multiple devices in the embodiments of the present disclosure are only for illustration, rather than to limit the scope of the messages or information.

After a meeting, an audio and video of the meeting may be converted into text through recognition processing. However, the meeting text usually has massive contents, and thus it is crucial to quickly and correctly identify statements including task intention. The content in the meeting is normally a record of discussions on one or more topics, and ultimately a conclusion is acquired or many other topics are derived from the meeting. Moreover, many to-do tasks are often assigned in the meeting. The meeting text of the meeting has plenty of words. Identifying the statements including task intention (to do) will greatly reduce the burden of organizing meeting minutes. A to-do statement may be a type of intention. However, currently, there is a problem of low efficiency and low accuracy in determining the to-do statements. In view of this, a method for processing meeting minutes is provided according to an embodiment of the present disclosure. Hereinafter, the method is introduced in conjunction with specific embodiments.

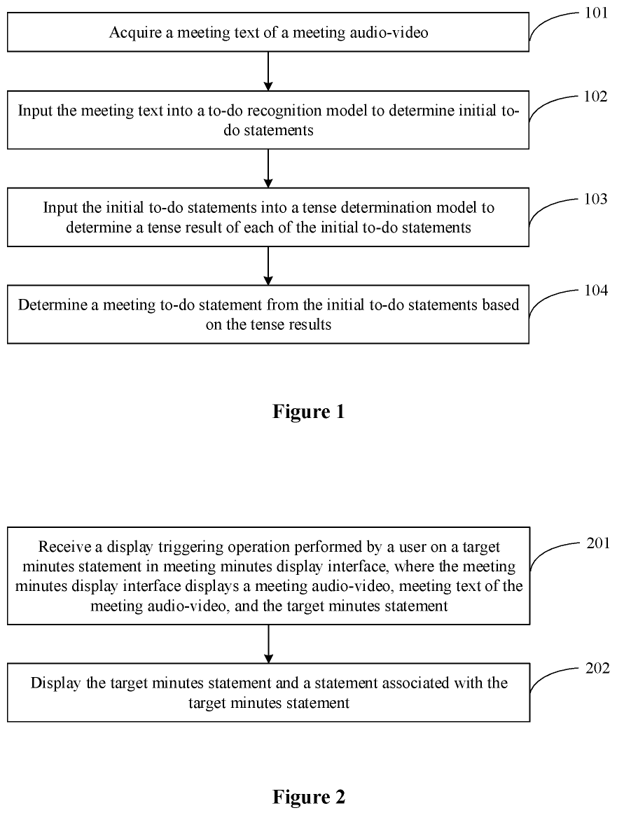

FIG. 1 is a schematic flow chart of a method for processing meeting minutes according to an embodiment of the present disclosure. The method may be performed by an apparatus for processing meeting minutes. The apparatus may be implemented in software and/or hardware and may normally be integrated in an electronic device. As shown in FIG. 1, the method includes the following steps 101 to 104.

In step 101, the apparatus for processing meeting minutes acquires a meeting text of a meeting audio-video.

The meeting audio-video is an audio and/or video for recording a process of a meeting. The meeting text is text content acquired by performing speech recognition on the meeting audio-video.

In the embodiment of the present disclosure, the apparatus may acquire the meeting text already gone through audio-video processing. Alternatively, the apparatus may acquire the meeting audio-video, and perform speech recognition on the meeting audio-video to acquire the meeting text.

In step 102, the apparatus inputs the meeting text into a to-do recognition model to determine initial to-do statements.

The to-do recognition model may be a pre-trained deep learning model for recognizing to-do statements in the meeting text. The deep learning model used herein is not limited.

In the embodiment of the present disclosure, before the step 102 is performed, the apparatus may generate the to-do recognition model. The to-do recognition model is generated by training an initial one-class classification model based on positive samples of the to-do statements to acquire the to-do recognition model. Considering boundaryless nature of negative samples, the one-class classification model is taken as an example of the to-do recognition model for describing the embodiment of the present disclosure. The one-class classification model is a special classification task model for which training samples only have positive labels, while other samples are classified as another class. In other words, a boundary of the positive samples is determined, and data outside the boundary is classified as another class.

The positive samples of the to-do statements may be samples each having a positive label, that is, the samples are determined as samples of the to-do statements in the meeting. The number of the positive samples of the to-do statements is not limited and may be determined according to the actual situations. Specifically, the apparatus may input the positive samples of the to-do statements into the initial one-class classification model for training the model, to acquire a trained one-class classification model, namely, the to-do recognition model.

In the embodiment of the present disclosure, the process of the apparatus inputting the meeting text into the to-do recognition model to determine the initial to-do statements may include: converting, by the apparatus, text statements in the meeting text into sentence vectors, and inputting the sentence vectors into the to-do recognition model to determine the initial to-do statements. The text statements are acquired by segmenting or dividing the meeting text in sentences, and there may be more than one text statement.

The apparatus may convert the text statements included in the meeting text into the sentence vectors through an embedding layer, input the sentence vectors into the pre-trained to-do recognition model to predict a classification result of the to-do statements, and determine statements with a return value as the initial to-do statements. Since the to-do recognition model is a one-class classification model, the classification thereof may be considered as being implemented by calculating a radius and a center of a ball in which the ball is the boundary of the positive samples, and a space inside the ball may represent a distribution space of the positive samples of the to-do statements.

According to the above solutions, the apparatus can recognize to-do statements in the meeting text using the one-class classification model, reducing the amount of data in training the deep learning model, improving the efficiency of training the model, and improving recognition accuracy.

In step 103, the apparatus inputs the initial to-do statements into a tense determination model to determine a tense result of each of the initial to-do statements.

Similar to case of the to-do recognition model, the tense determination model is a pre-trained model for determining a tense of each of the initial to-do statements acquired through recognition in the previous step. The deep learning model used herein is not limited. The tense is a form for representing a behavior, an action, or a state under various time conditions. The tense results may include a past tense, a present tense, and a future tense. The past tense is used to represent past time, the present tense is used to represent present time, and the future tense is used to represent future time.

Specifically, after recognizing the meeting text using the to-do recognition model to determine the initial to-do statements, the apparatus may input the initial to-do statements into the pre-trained tense determination model to further determine a tense of each of the initial to-do statements, to obtain a tense result. The tense determination model may be a three-class classification model.

In step 104, the apparatus determines a meeting to-do statement from the initial to-do statements based on the tense results.

The meeting to-do statement is different from the initial to-do statement, and is a final determined statement with the to-do intention.

Specifically, the process of determining the meeting to-do statement from the initial to-do statements based on the tense results may include determining the initial to-do statement of which the tense result is the future tense as the meeting to-do statement. After the tense result of each of the initial to-do statements is determined, the apparatus may determine the initial to-do statement(s) with the future tense as the meeting to-do statement(s), and delete initial to-do statements with the past tense and the present tense, and finally the meeting to-do statement is acquired.

In the embodiment of the present disclosure, the apparatus performs the to-do intention recognition on the meeting text using the deep learning model, helping the user organize the meeting to-do statements in the meeting minutes, and improving work efficiency of the user. Compared with the conventional machine learning method, the one-class classification model is used as the to-do recognition model, which can greatly improve the accuracy of determining the negative samples. The negative samples in the to-do statements have no boundary, and the model has high accuracy, which can greatly improve the user experience.

In the solutions for processing meeting minutes according to the embodiment of the present disclosure, the apparatus acquires a meeting text of a meeting audio-video, inputs the meeting text into a to-do recognition model to determine initial to-do statements, inputs the initial to-do statements into a tense determination model to determine a tense result of each of the initial to-do statements, and determines a meeting to-do statement from the initial to-do statements based on the tense results. According to the above technical solutions, tense determination is additionally perform on the basis of recognizing the initial to-do statements in the meeting text of the meeting audio-video, avoiding to identify a statement of already fulfilled task as the meeting to-do statement, greatly improving the accuracy of determining the meeting to-do statement, thereby improving the work efficiency of the user based on the meeting to-do statement, and improving the experience effect of the user.

In some embodiments, after the meeting text of the meeting audio-video is acquired, the method may further include: performing sentence division on the meeting text to acquire multiple text statements; and pre-processing the text statements based on a predetermined rule to filter the text statements. In an embodiment, the process of pre-processing the text statements based on the predetermined rule includes at least one of: deleting a text statement which does not include words for expressing intention; deleting a text statement with a text length less than a length threshold; and deleting a text statement lack of nouns.

The text statements are acquired by segmenting or dividing the meeting text into sentences. Specifically, the segmentation may be performed on the meeting text based on punctuations, to convert the meeting text into multiple text statements. The predetermined rule may be a rule for processing multiple text statements, which is not limited herein. For example, the predetermined rule may be deleting a stop word and/or deleting a duplicate word.

In the embodiment of the present disclosure, sentence division is performed on the meeting text to acquire the multiple text statements, word division processing is performed on each of the text statements to acquire a word division processing result, and the text statements are pre-processed based on the predetermined rule and the word division processing result, to filter the text statements. The text statements passing the pre-processing are more likely to be the to-do statements. The process of pre-processing the text statements may include determining, for a word division processing result of each of the text statements, whether the word division processing result includes words expressing intention and/or nouns, and deleting text statements which do not include words for expressing intention and/or nouns. The words expressing intention are pre-organized words that may include the to-do intention. For example, if a text statement includes words “needs to be completed”, the text statement may include the to-do intention, and “needs to be completed” is the word expressing intention. In the embodiment of the present disclosure, a vocabulary storing words expressing intention and/or nouns may be set for use in the pre-processing.

In an embodiment, the process of pre-processing the text statements may include determining a text length of each of the text statements, comparing the text length with the length threshold, and deleting the text statement with the text length less than the length threshold. The length threshold is a predetermined statement length. A text statement with a too short length may not form a sentence. Therefore, the text statements with the too short length are deleted by setting the length threshold.

In an embodiment, the process of pre-processing the text statements based on the predetermined rule may include: performing sentence pattern matching on each of the text statements based on a predetermined sentence pattern, and deleting a text statement that does not match the predetermined sentence pattern. The predetermined sentence pattern may be understood as a sentence pattern that has a high possibility in indicating to-do intention. The predetermined sentence pattern may include multiple forms of sentence patterns. For example, the predetermined sentence pattern may be in the form of subject+preposition+time word+verb+object, for example, a statement in such sentence pattern such as “Xiao Wang, complete your homework tomorrow” is the to-do statement. The sentence pattern matching is performed on each of the text statements, and the text statement that does not match the predetermined sentence pattern is deleted.

In the embodiment of the present disclosure, after the meeting text is acquired, the text statements included in the meeting text may be pre-processed based on multiple predetermined rules. Since the predetermined rules are related to the to-do intention, the possibility that the pre-processed text statements are the to-do statements is high, thereby improving the efficiency and the accuracy of subsequently determining the to-do statements.

FIG. 2 is a schematic flow chart of a method for processing meeting minutes according to another embodiment of the present disclosure. The method may be performed by an apparatus for processing meeting minutes. The apparatus may be implemented in software and/or hardware, and may normally be integrated in an electronic device. As shown in FIG. 2, the method includes the following steps 201 and 202.

In step 201, the apparatus receives a display triggering operation performed by a user on a target minutes statement in meeting minutes display interface, where the meeting minutes display interface displays a meeting audio-video, meeting text of the meeting audio-video, and the target minutes statement.

The meeting minutes display interface is an interface for displaying meeting minutes generated in advance. The meeting audio-video and the meeting text are displayed on different areas of the meeting minutes display interface. The meeting minutes display interface may be provided with an audio-video area, a subtitle area, a meeting minutes display area and other areas, to display contents related to meeting, such as the meeting audio-video, the meeting text of the meeting audio-video, and the meeting minutes. The display triggering operation is an operation for triggering the display of the to-do statement in the meeting minutes. The manner for triggering the display is not limited herein. For example, the display triggering operation may be a click and/or mouse-over operation on the meeting to-do statement.

The minutes statement is a statement in the meeting minutes, and is displayed on the meeting minutes display area. The minutes statement includes the meeting to-do statement, and the meeting to-do statement is a minutes statement corresponding to a type of minutes and is the to-do statement determined in the above embodiment. The meeting minutes are generated from main meeting contents by processing the meeting audio-video. There are various types of the meeting minutes. In the embodiment of the present disclosure, the meeting minutes may be of the type of topic, agenda, discussion, conclusion, to-do task, or the like. The meeting to-do statement is a statement in the type of the to-do task.

In the embodiment of the present disclosure, when a user browses the content in the meeting minutes display interface, a user terminal may receive a display triggering operation performed by the user on one target minutes statement in the meeting minutes.

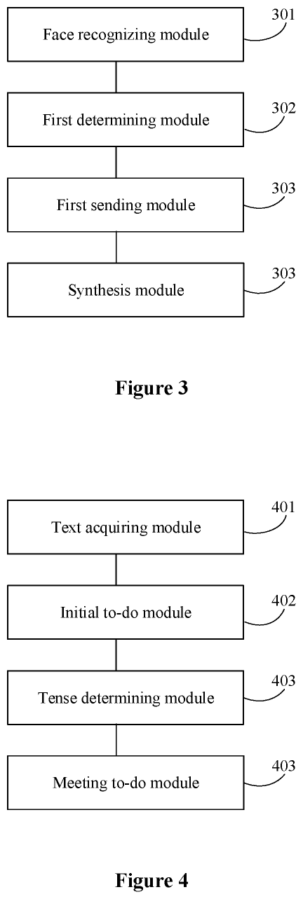

For example, FIG. 3 is a schematic diagram of a meeting minutes display interface according to an embodiment of the present disclosure. As shown in FIG. 3, the meeting minutes are displayed in a first area 11 of the meeting minutes display interface 10, a meeting video is displayed in an area above the first area 11, the meeting text is displayed in a second area 12, and a meeting audio is displayed in an area at the bottom of the meeting minutes display interface 10. In an embodiment, a timeline of the meeting audio is displayed. FIG. 3 shows five types of meeting minutes, which are topic, agenda, discussion, conclusion and to-do task. The item of to-do task includes three meeting to-do statements. The arrow in FIG. 3 may represent a display triggering operation on a first meeting to-do statement.

The meeting text in FIG. 3 may be divided into subtitle segments based on different users participating in the meeting. FIG. 3 shows subtitle segments for three users, i.e., a user 1, a user 2 and a user 3. In FIG. 3, a title “team review meeting” of the meeting and contents related to the meeting are further displayed on the top of the meeting minutes display interface 10. In FIG. 3, “10:00 a.m. on 2019.12.30” indicates a starting time of the meeting, “1 h30 m30 s” indicates that the meeting lasts for 1 hour 30 minutes and 20 seconds, and “16” indicates the number of participants. It can be understood that the meeting minutes display interface 10 in FIG. 3 is exemplary and the layout of the meeting minutes display interface 10 is exemplary. The layout and the presentation may be determined according to the actual situation.

In step 202, the apparatus displays the target minutes statement and a statement associated with the target minutes statement.

The statement associated with the target minutes statement is included in the meeting text and is a subtitle statement that has a positional association with the target minutes statement. The number of the statement associated with the target minutes statement may be set according to the actual situation. For example, the statement associated with the target minutes statement may be two subtitle statements preceding and succeeding the target minutes statement in the meeting text. The number of the associated statements may be 2. The subtitle statements may be a component unit of the meeting text, and may be acquired by performing sentence division on the meeting text. The meeting text may include multiple subtitle statements, and the number of the subtitle statements is not limited herein.

In the embodiment of the present disclosure, the process of displaying the target minutes statement and the statement associated with the target minutes statement may include: displaying the target minutes statement and the statement associated with the target minutes statement in a floating window in the meeting minutes display interface. The floating window may be presented in an area of the meeting minutes display interface. A location of the floating window may be set according to the actual situation. For example, the location of the floating window may be any location that does not cover a current target minutes statement.

On receipt of the display triggering operation on the target minutes statement, the apparatus may display a floating window to the user, and present the target minutes statement and the statement associated with the target minutes statement in the floating window. In the embodiment of the present disclosure, the target minutes statement and several sentences preceding and succeeding the target minutes statement are presented, avoiding the possibility that the user has difficulty to understand if the target minutes statement is separately presented, thereby facilitating the user to understand the content and improving the display effect of the minutes statement.

For example, as shown in FIG. 3, the first underlined meeting to-do statement with the type of the to-do task in the meeting minutes displayed in the first area 11 is a target meeting to-do statement. Once the display of the target meeting to-do statement is triggered, the target meeting to-do statement and statement(s) associated with the target meeting to-do statement are displayed in the floating window 13. The associated statements displayed in the floating window 13 in FIG. 3 include a sentence preceding the target meeting to-do statement and a sentence succeeding the target meeting to-do statement.

In some embodiments, the method of processing meeting minutes may further include: playing the meeting audio-video based on a time period associated with the target minutes statement, and distinctively displaying a subtitle associated with the target minutes statement in the meeting text. The subtitle associated with the target minutes statement is a subtitle corresponding to the target minutes statement in a subtitle text. The time period associated with the target minutes statement is a time period in which an original meeting speech corresponding to the subtitle associated with the target minutes statement is located in the meeting audio-video. The time period associated with the target minutes statement may include a starting time instant and an ending time instant.

On receipt of the display triggering operation performed by the user on the target minutes statement, the apparatus may further play the meeting audio-video at the starting time instant in the time period associated with the target minutes statement, and stop playing the meeting audio-video at the ending time instant; cause the meeting text to jump to a location of the subtitle associated with the target minutes statement, and distinctively display the subtitle associated with the target minutes statement in a predetermined way. In an embodiment, the predetermined way may be any feasible way to display the subtitle associated with the target minutes statement distinctively from other parts of the meeting text. For example, the predetermined way may include, but is not limited to, at least one of highlighting, bold font and adding an underline.

According to the above solutions, the user may implement associated interaction with the meeting audio-video and relevant contents in the meeting text, by triggering through the interaction with the minutes statement in the meeting minutes display interface, and the interactive experience effect of the user is improved. The interaction with the minutes statement, the interaction with the meeting audio-video, and the interaction with the meeting text are associated with each other, so that the user can intuitively understand a relationship between the minutes statement, the meeting audio-video and the meeting text, thereby helping the user to accurately understand the meeting content.

It can be understood that, the various steps and features in the embodiments of the present disclosure may be superimposed and combined with other embodiments (including but not limited to the embodiment shown in FIG. 1 and the implementation methods of the embodiments) of the present disclosure if there is no contradiction.

In the solutions for processing meeting minutes according to the embodiments of the present disclosure, the apparatus for processing meeting minutes receives a display triggering operation performed by a user on a target minutes statement in meeting minutes display interface, where the meeting minutes display interface displays a meeting audio-video, meeting text of the meeting audio-video, and the target minutes statement; and displays the target minutes statement and a statement associated with the target minutes statement. According to the above technical solutions, after more accurate minutes statements are determined, on receipt of a triggering operation performed by the user on one of the minutes statements, the apparatus may present the minutes statement and several sentences in the front of and succeeding the minutes statement, avoiding the possibility that it is difficult for the user to understand when the minutes statement is separately presented, facilitating the user to understand the content, and making the display effect of the minutes statement better, thereby improving the experience effect of the user.

FIG. 4 is a schematic structural diagram of an apparatus for processing meeting minutes according to an embodiment of the present disclosure. The apparatus may be implemented in software and/or hardware and may normally be integrated in an electronic device. As shown in FIG. 4, the apparatus includes a text acquiring module 401, an initial to-do module 402, a tense determining module 403 and a meeting to-do module 404.

The text acquiring module 401 is configured to acquire a meeting text of a meeting audio-video.

The initial to-do module 402 is configured to input the meeting text into a to-do recognition model to determine initial to-do statements.

The tense determining module 403 is configured to input the initial to-do statements into a tense determination model to determine a tense result of each of the initial to-do statements.

The meeting to-do module 404 is configured to determine a meeting to-do statement from the initial to-do statements based on the tense results.

In an embodiment, the initial to-do module 402 is configured to convert text statements in the meeting text into sentence vectors, and input the sentence vectors into the to-do recognition model to determine the initial to-do statements, where the to-do recognition model is a one-class classification model.

In an embodiment, the apparatus further includes a model training module. The model training module is configured to train an initial one-class classification model based on positive samples of the to-do statements to acquire the to-do recognition model.

In an embodiment, the meeting to-do module 404 is configured to determine an initial to-do statement of which a tense result is a future tense as the meeting to-do statement.

In an embodiment, the apparatus further includes a pre-processing module. The pre-processing module is configured to, after the meeting text of the meeting audio-video is acquired, perform sentence division on the meeting text to acquire multiple text statements; and pre-process the text statements based on a predetermined rule to filter the text statements.

In an embodiment, the pre-processing module is configured to: delete a text statement which does not include words for expressing intention; and/or delete a text statement with a text length less than a length threshold; and/or delete a text statement lack of nouns.

In an embodiment, the pre-processing module is configured to perform sentence pattern matching on each of the text statements based on a predetermined sentence pattern, and delete a text statement that does not match the predetermined sentence pattern.

The apparatus for processing meeting minutes according to the embodiments of the present disclosure acquires a meeting text of a meeting audio-video through the coordination between various modules; inputs the meeting text into a to-do recognition model to determine initial to-do statements; inputs the initial to-do statements into a tense determination model to determine a tense result of each of the initial to-do statements; and determines a meeting to-do statement from the initial to-do statements based on the tense results. According to the above technical solutions, tense determination is additionally perform on the basis of recognizing the initial to-do statements in the meeting text of the meeting audio-video, avoiding to identify a statement of already fulfilled task as the meeting to-do statement, greatly improving the accuracy of determining the meeting to-do statement, thereby improving the work efficiency of the user based on the meeting to-do statement, and improving the experience effect of the user.

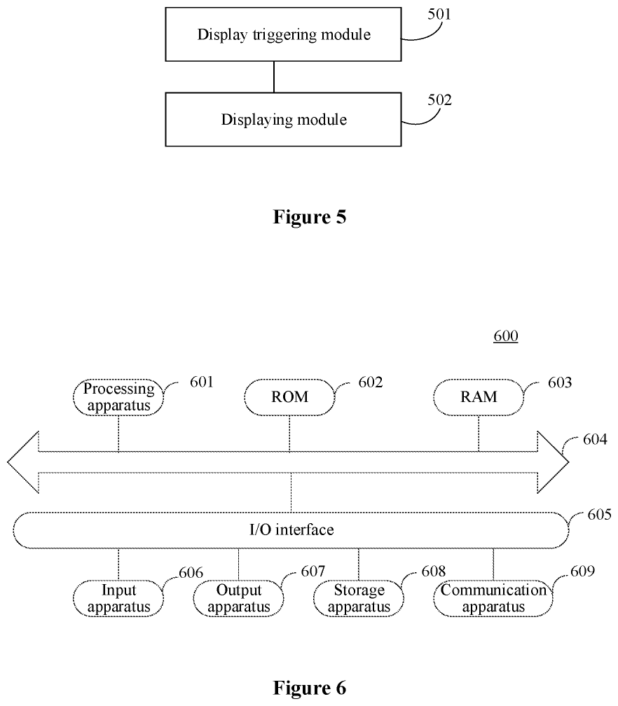

FIG. 5 is a schematic structural diagram of an apparatus for processing meeting minutes according to an embodiment of the present disclosure. The apparatus may be implemented in software and/or hardware and may normally be integrated in an electronic device. As shown in FIG. 5, the apparatus includes a display triggering module 501 and a displaying module 502.

The display triggering module 501 is configured to receive a display triggering operation performed by a user on a target minutes statement in meeting minutes display interface, where the meeting minutes display interface displays a meeting audio-video, meeting text of the meeting audio-video, and the target minutes statement.

The displaying module 502 is configured to display the target minutes statement and a statement associated with the target minutes statement.

In an embodiment, the statement associated with the target minutes statement is included in the meeting text and is a subtitle statement that has a positional association with the target minutes statement, the meeting text includes multiple subtitle statements, and the target minutes statement includes a target meeting to-do statement.

In an embodiment, the displaying module 502 is configured to display the target minutes statement and the statement associated with the target minutes statement in a floating window in the meeting minutes display interface.

In an embodiment, the apparatus further includes an association interaction module. The association interaction module is configured to play the meeting audio-video based on a time period associated with the target minutes statement, and distinctively display a subtitle associated with the target minutes statement in the meeting text.

The apparatus for processing meeting minutes according to the embodiments of the present disclosure receives a display triggering operation performed by a user on a target minutes statement in meeting minutes display interface through the coordination between various modules, where the meeting minutes display interface displays a meeting audio-video, meeting text of the meeting audio-video, and the target minutes statement; and displays the target minutes statement and a statement associated with the target minutes statement. According to the above technical solutions, after more accurate minutes statements are determined, on receipt of a triggering operation performed by the user on one of the minutes statements, the minutes statement and several sentences in the front of and succeeding the minutes statement are presented, avoiding the possibility that the user has difficulty to understand if the target minutes statement is separately presented, facilitating the user to understand the content, improving the display effect of the minutes statement, and improving the experience effect of the user.

FIG. 6 is a schematic structural diagram of an electronic device according to an embodiment of the present disclosure. Reference is made to FIG. 6, which shows a schematic structural diagram of an electronic device 600 according to an embodiment of the present disclosure. The electronic device 600 according to the embodiment of the present disclosure may include, but is not limited to, a mobile terminal, such as a mobile phone, a laptop, a digital broadcast receiver, a personal digital assistant (PDA), a tablet (PAD), a portable multimedia player (PMP), a vehicle-mounted terminal (such as in-vehicle navigation terminal); and a fixed terminal, such as a digital TV and a desktop computer. The electronic device shown in FIG. 6 is only exemplary, and should not impose any limitation on the function and scope of application of the embodiments of the present disclosure.

As shown in FIG. 6, the electronic device 600 may include a processing apparatus (such as a central processing unit or a graphics processor) 601, which may execute various operations and processing based on a program stored in a read-only memory (ROM) 602 or a program loaded from a storage 608 into a random-access memory (RAM) 603. The RAM 603 is further configured to store various programs and data required by the electronic device 600. The processing apparatus 601, the ROM 602 and the RAM 603 are connected to each other through a bus 604. An input/output (I/O) interface 605 is also connected to the bus 604.

Generally, the I/O interface 605 may be connected to: an input apparatus 606, such as a touch screen, a touch panel, a keyboard, a mouse, a camera, a microphone, an accelerometer, and a gyroscope; an output apparatus 607, such as a liquid crystal display (LCD), a speaker, and a vibrator; a storage apparatus 608 such as a magnetic tape and a hard disk; and a communication apparatus 609. The communication apparatus 609 enables wireless or wired communication between the electronic device 600 and other devices for data exchanging. Although FIG. 6 shows an electronic device 600 having various apparatuses, it should be understood that the illustrated apparatuses are not necessarily required to all be implemented or embodied. Alternatively, more or fewer apparatuses may be implemented or included.

Particularly, according to an embodiment of the present disclosure, the process described above in conjunction with flow charts may be implemented as a computer software program. For example, a computer program product is further provided according to an embodiment of the present disclosure. The computer program product includes a computer program carried on a non-transitory computer-readable medium. The computer program includes program codes for performing the method shown in the flow chart. In the embodiment, the computer program may be downloaded and installed from the network via the communication apparatus 609, or installed from the storage apparatus 608, or installed from the ROM 602. When the computer program is executed by the processing apparatus 601, the functions defined in the method for processing meeting minutes according to the embodiments of the present disclosure are performed.

It should be noted that, the computer-readable medium in the present disclosure may be a computer-readable signal medium or a computer-readable storage medium or any combination thereof. The computer-readable storage medium may include, but is not limited to, a system, an apparatus, or a device in an electronic, magnetic, optical, electromagnetic, infrared, or semi-conductive form, or any combination thereof. Concrete examples of the computer-readable storage medium may include, but is not limited to, an electrical connection with one or more wires, a portable computer disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device or any suitable combination thereof. In the present disclosure, the computer-readable storage medium may be any tangible medium including or storing a program, and the program may be used by or in combination with an instruction execution system, apparatus, or device. In the present disclosure, the computer-readable signal medium may be a data signal in a baseband or transmitted as a part of a carrier wave and carrying computer-readable program codes. The transmitted data signal may be in various forms, including but not limited to an electromagnetic signal, an optical signal or any proper combination thereof. The computer-readable signal medium may alternatively be any computer-readable medium other than the computer-readable storage medium. The computer-readable medium may send, propagate or transmit a program for use by or use in combination with an instruction execution system, apparatus or a component. The program codes stored in the computer-readable medium may be transmitted via any proper medium including but not limited to: a wire, an optical cable, radio frequency (RF) and the like, or any proper combination thereof.

In some embodiments, a user terminal and a server may communicate in any currently known or future developed network protocol such as a hypertext transfer protocol (HTTP), and may be interconnected with any form or medium of digital data communication (for example, communication network). The communication network includes, for example, a local area network (LAN), a wide area network (WAN), an Internet network (for example, the Internet), and an end-to-end network (for example, an ad hoc end-to-end network), and any currently known or future developed network.

The computer-readable medium may be included in the electronic device, or may exist alone without being assembled into the electronic device.

The computer-readable medium carries one or more programs. When the one or more programs are executed by the electronic device, the electronic device acquires a meeting text of a meeting audio-video; inputs the meeting text into a to-do recognition model to determine initial to-do statements; and inputs the initial to-do statements into a tense determination model to determine a tense result of each of the initial to-do statements; and determine a meeting to-do statement from the initial to-do statements based on the tense results.

Alternatively, the computer-readable medium carries one or more programs. The one or more programs, when being executed by the electronic device, cause the electronic device to: receive a display triggering operation performed by a user on a target minutes statement in meeting minutes display interface, where the meeting minutes display interface displays a meeting audio-video, meeting text of the meeting audio-video, and the target minutes statement; and display the target minutes statement and a statement associated with the target minutes statement.

The computer program codes for performing the operations in the present disclosure may be written in one or more programming languages or combinations thereof. The programming languages include, but are not limited to, an object-oriented programming language, such as Java, Smalltalk, and C++, and a conventional procedural programming language, such as C language or a similar programming language. The program codes may be entirely executed on a user computer, partially on the user computer, as a standalone software package, partially on the user computer and partially on a remote computer, or entirely on the remote computer or a server. In the case of involving a remote computer, the remote computer may be connected to a user computer or an external computer (for example, the remote computer may be connected through Internet connection by an Internet service provider) through any kind of network including the local area network (LAN) or the wide area network (WAN).

Flow charts and block diagrams in the drawings show architecture, functions and operations that can be implemented by the system, method and computer program product according to the embodiments of the present disclosure. Each block in the flow charts or the block diagrams may represent a module, a program segment, or a part of codes, and the module, the program segment, or the part of codes includes one or more executable instructions for implementing the specified logical function. It should be noted that, in some alternative implementations, the functions marked in blocks may be performed in an order different from the order shown in the drawings. For example, two blocks shown in succession may actually be executed in parallel, or sometimes may be executed in a reverse order, which depends on the functions involved. It should be noted that each block in the block diagrams and/or the flow charts and a combination of blocks in the block diagrams and/or the flow charts may be implemented by using a dedicated hardware-based system for performing a specified function or operation, or may be implemented by using a combination of dedicated hardware and a computer instruction.

The units mentioned in the description of the embodiments of the present disclosure may be implemented by means of software, or otherwise by means of hardware. In some circumstances, names of units do not constitute a limitation on the units themselves.

The functions described above in the present disclosure may be performed at least in part by one or more hardware logic components. For example, without limitation, exemplary types of hardware logic components that may be used include: field programmable gate array (FPGA), application specific integrated circuit (ASIC), application specific standard product (ASSP), system on chip (SOC), complex programmable logic device (CPLD) and the like.

In the present disclosure, a machine-readable medium may be a tangible medium including or storing a program that is used or in combination with an instruction execution system, apparatus or device. The machine-readable medium may be a machine-readable signal medium or a machine-readable storage medium. The machine-readable medium may include, but is not limited to, a system, an apparatus or a device in an electronic, magnetic, optical, electromagnetic, infrared, or semi-conductive form, or any combination thereof. Concrete examples of the machine-readable storage medium may include, an electrical connection with one or more wires, a portable computer disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device or any suitable combination thereof.

According to one or more embodiments of the present disclosure, a method for processing meeting minutes is provided. The method includes:
acquiring a meeting text of a meeting audio-video;
inputting the meeting text into a to-do recognition model to determine initial to-do statements;
inputting the initial to-do statements into a tense determination model to determine a tense result of each of the initial to-do statements; and
determining a meeting to-do statement from the initial to-do statements based on the tense results.

According to one or more embodiments of the present disclosure, in the method for processing meeting minutes according to the present disclosure, the inputting the meeting text into a to-do recognition model to determine initial to-do statements includes:
converting text statements in the meeting text into sentence vectors, and inputting the sentence vectors into the to-do recognition model to determine the initial to-do statements, where the to-do recognition model is a one-class classification model.

According to one or more embodiments of the present disclosure, in the method for processing meeting minutes according to the present disclosure, the to-do recognition model is generated by:
training an initial one-class classification model based on positive samples of the to-do statements to acquire the to-do recognition model.

According to one or more embodiments of the present disclosure, in the method for processing meeting minutes according to the present disclosure, the determining a meeting to-do statement from the initial to-do statements based on the tense results includes:
determining the initial to-do statement of which the tense result is a future tense as the meeting to-do statement.

According to one or more embodiments of the present disclosure, in the method for processing meeting minutes according to the present disclosure, after the acquiring a meeting text of a meeting audio-video, the method further includes:
performing sentence division on the meeting text to acquire multiple text statements; and
pre-processing the text statements based on a predetermined rule to filter the text statements.

According to one or more embodiments of the present disclosure, in the method for processing meeting minutes according to the present disclosure, the pre-processing the text statements based on a predetermined rule includes at least one of:
deleting a text statement which does not include words for expressing intention;
deleting a text statement with a text length less than a length threshold; and
deleting a text statement lack of nouns.

According to one or more embodiments of the present disclosure, in the method for processing meeting minutes according to the present disclosure, the pre-processing the text statements based on a predetermined rule includes:
performing sentence pattern matching on each of the text statements based on a predetermined sentence pattern, and deleting a text statement that does not match the predetermined sentence pattern.

According to one or more embodiments of the present disclosure, a method for processing meeting minutes according to the present disclosure includes:
receiving a display triggering operation performed by a user on a target minutes statement in meeting minutes display interface, where the meeting minutes display interface displays a meeting audio-video, meeting text of the meeting audio-video, and the target minutes statement; and
displaying the target minutes statement and a statement associated with the target minutes statement.

According to one or more embodiments of the present disclosure, in the method for processing meeting minutes according to the present disclosure, the statement associated with the target minutes statement is included in the meeting text and is a subtitle statement that has a positional association with the target minutes statement, the meeting text includes multiple subtitle statements, and the target minutes statement includes a target meeting to-do statement.

According to one or more embodiments of the present disclosure, in the method for processing meeting minutes according to the present disclosure, the displaying the target minutes statement and a statement associated with the target minutes statement includes displaying the target minutes statement and the statement associated with the target minutes statement in a floating window in the meeting minutes display interface.

According to one or more embodiments of the present disclosure, the method for processing meeting minutes according to the present disclosure further includes: playing the meeting audio-video based on a time period associated with the target minutes statement, and distinctively displaying a subtitle associated with the target minutes statement in the meeting text.

According to one or more embodiments of the present disclosure, an apparatus for processing meeting minutes is provided according to the present disclosure. The apparatus includes:
a text acquiring module, configured to acquire a meeting text of a meeting audio-video;
an initial to-do module, configured to input the meeting text into a to-do recognition model to determine initial to-do statements;
a tense determining module, configured to input the initial to-do statements into a tense determination model to determine a tense result of each of the initial to-do statements; and
a meeting to-do module, configured to determine a meeting to-do statement from the initial to-do statements based on the tense results.

According to one or more embodiments of the present disclosure, in the apparatus for processing meeting minutes according to the present disclosure, the initial to-do module is configured to convert text statements in the meeting text into sentence vectors, and input the sentence vectors into the to-do recognition model to determine the initial to-do statements, where the to-do recognition model is a one-class classification model.

According to one or more embodiments of the present disclosure, the apparatus for processing meeting minutes according to the present disclosure further includes a model training module. The model training module is configured to train an initial one-class classification model based on positive samples of the to-do statements to acquire the to-do recognition model.

According to one or more embodiments of the present disclosure, in the apparatus for processing meeting minutes according to the present disclosure, the meeting to-do module is configured to: determine an initial to-do statement of which a tense result is a future tense as the meeting to-do statement.

According to one or more embodiments of the present disclosure, the apparatus for processing meeting minutes according to the present disclosure further includes a pre-processing module. The pre-processing module is configured to, after the meeting text of the meeting audio-video is acquired, perform sentence division on the meeting text to acquire multiple text statements; and pre-process the text statements based on a predetermined rule to filter the text statements.

According to one or more embodiments of the present disclosure, in the apparatus for processing meeting minutes according to the present disclosure, the pre-processing module is configured to at least one of: delete a text statement which does not include words for expressing intention; delete a text statement with a text length less than a length threshold; and delete a text statement lack of nouns.

According to one or more embodiments of the present disclosure, in the apparatus for processing meeting minutes according to the present disclosure, the pre-processing module is configured to perform sentence pattern matching on each of the text statements based on a predetermined sentence pattern, and delete a text statement that does not match the predetermined sentence pattern.

According to one or more embodiments of the present disclosure, an apparatus for processing meeting minutes is provided according to the present disclosure. The apparatus includes:
a display triggering module, configured to receive a display triggering operation performed by a user on a target minutes statement in meeting minutes display interface, where the meeting minutes display interface displays a meeting audio-video, meeting text of the meeting audio-video, and the target minutes statement; and
a displaying module, configured to display the target minutes statement and a statement associated with the target minutes statement.

According to one or more embodiments of the present disclosure, in the apparatus for processing meeting minutes according to the present disclosure, the statement associated with the target minutes statement is included in the meeting text and is a subtitle statement that has a positional association with the target minutes statement, the meeting text includes multiple subtitle statements, and the target minutes statement includes a target meeting to-do statement.

According to one or more embodiments of the present disclosure, in the apparatus for processing meeting minutes according to the present disclosure, the displaying module is configured to: display the target minutes statement and the statement associated with the target minutes statement in a floating window in the meeting minutes display interface.

According to one or more embodiments of the present disclosure, the apparatus for processing meeting minutes according to the present disclosure further includes an association interaction module. The association interaction module is configured to play the meeting audio-video based on a time period associated with the target minutes statement, and distinctively display a subtitle associated with the target minutes statement in the meeting text.

According to one or more embodiments of the present disclosure, an electronic device is provided according to the present disclosure. The electronic device includes: a processor and a memory. The memory is configured to store instructions executable on the processor. The processor is configured to read the executable instructions from the memory and execute the instructions to perform the method for processing meeting minutes according to any one of the embodiments of the present disclosure.

According to one or more embodiments of the present disclosure, a computer-readable storage medium is provided according to the present disclosure. The storage medium stores a computer program. The computer program is used to perform the method for processing meeting minutes according to any one of the embodiments of the present disclosure.

The above description includes merely preferred embodiments of the present disclosure and explanations of technical principles used. Those skilled in the art should understand that the scope of the present disclosure is not limited to technical solutions formed by a specific combination of the above technical features, but covers other technical solutions formed by any combination of the above technical features or equivalent features thereof without departing from an inventive concept of the present disclosure. For example, technical solutions are formed by replacing the above features with the technical features (but not limited to) with similar functions disclosed in the present disclosure.

In addition, although the operations are described in a specific order, this should not be understood as requiring these operations to be performed in the specific order shown or in a sequential order. Under certain circumstances, multitasking and processing in parallel may be advantageous. In addition, although several specific implementation details are included in the above discussion, these should not be interpreted as limiting the scope of the present disclosure. Some features described in the context of individual embodiments may further be implemented in combination in one embodiment. In addition, various features described in the context of a single embodiment may be implemented in multiple embodiments individually or in any suitable sub-combination.

Although the subject matter is described in language specific to structural features and/or logical actions of methods, it should be understood that the subject matter defined in the claims is not limited to the specific features or actions described above. In addition, the specific features and actions described above are merely examples for implementing the claims.

1. A method for processing meeting minutes, comprising:
acquiring a meeting text of a meeting audio-video;
inputting the meeting text into a to-do recognition model to determine initial to-do statements;
inputting the initial to-do statements into a tense determination model to determine a tense result of each of the initial to-do statements; and
determining a meeting to-do statement from the initial to-do statements based on the tense results.

2. The method according to claim 1, wherein the inputting the meeting text into the to-do recognition model to determine initial to-do statements comprises:
converting text statements in the meeting text into sentence vectors, and inputting the sentence vectors into the to-do recognition model to determine the initial to-do statements, wherein the to-do recognition model is a one-class classification model.

3. The method according to claim 1, wherein the to-do recognition model is generated by:
training an initial one-class classification model based on positive samples of the to-do statements to acquire the to-do recognition model.

4. The method according to claim 1, wherein the determining the meeting to-do statement from the initial to-do statements based on the tense results comprises:
determining the initial to-do statement of which the tense result is a future tense as the meeting to-do statement.

5. The method according to claim 1, wherein after acquiring the meeting text of the meeting audio-video, the method further comprises:
performing sentence division on the meeting text to acquire a plurality of text statements; and
pre-processing the text statements based on a predetermined rule to filter the text statements.

6. The method according to claim 5, wherein pre-processing the text statements based on the predetermined rule comprises at least one of:
deleting a text statement which does not include words for expressing intention;
deleting a text statement with a text length less than a length threshold; and
deleting a text statement lack of nouns.

7. The method according to claim 5, wherein pre-processing the text statements based on the predetermined rule comprises:
performing sentence pattern matching on each of the text statements based on a predetermined sentence pattern, and deleting a text statement that does not match the predetermined sentence pattern.

8. A method for processing meeting minutes, comprising:
receiving a display triggering operation performed by a user on a target minutes statement in a meeting minutes display interface, wherein the meeting minutes display interface displays a meeting audio-video, meeting text of the meeting audio-video, and the target minutes statement; and
displaying the target minutes statement and a statement associated with the target minutes statement.

9. The method according to claim 8, wherein the statement associated with the target minutes statement is comprised in the meeting text and is a subtitle statement that has a positional association with the target minutes statement, the meeting text comprises a plurality of subtitle statements.

10. The method according to claim 23, wherein displaying the target minutes statement and the statement associated with the target minutes statement comprises:
displaying the target minutes statement and the statement associated with the target minutes statement in a floating window in the meeting minutes display interface.

11. The method according to claim 8, further comprising:
playing the meeting audio-video based on a time period associated with the target minutes statement, and distinctively displaying a subtitle associated with the target minutes statement in the meeting text.

12-13. (canceled)

14. An electronic device, comprising:
a processor; and
a memory configured to store instructions executable on the processor, wherein the processor is configured to read the executable instructions from the memory and execute the instructions to perform;
acquiring a meeting text of a meting audio-video;
inputting the meeting text into a to-do recognition model to determine initial to-do statements;
inputting the initial to-do statements into a tense determination model to determine a tense result of each of the initial to-do statements; and
determining a meeting to-do statement from the initial to-do statements on the tense results.

15. (canceled)

16. The electronic device according to claim 14, wherein the processor is further configured to perform:
converting text statements in the meeting text into sentence vectors, and inputting the sentence vectors into the to-do recognition model to determine the initial to-do statements, wherein the to-do recognition model is a one-class classification model.

17. The electronic device according to claim 14, wherein the to-do recognition model is generated by:
training an initial one-class classification model based on positive samples of the to-do statements to acquire the to-do recognition model.

18. The electronic device according to claim 14, wherein the processor is further configured to perform:
determining the initial to-do statement of which the tense result is a future tense as the meeting to-do statement.

19. The electronic device according to claim 14, wherein the processor is further configured to perform:
performing sentence division on the meeting text to acquire a plurality of text statements; and
pre-processing the text statements based on a predetermined rule to filter the text statements.

20. An electronic device, comprising:
a processor; and
a memory configured to store instructions executable on the processor, wherein the processor is configured to read the executable instructions from the memory and execute the instructions to perform:
receiving a display triggering operation performed by a user on a target minutes statement in a meeting minutes display interface, wherein the meeting minutes display interface displays a meeting audio-video, meeting text of the meeting audio-video, and the target minutes statement; and
displaying the target minutes statement and a statement associated with the target minutes statement.

21. The electronic device according to claim 20, wherein the statement associated with the target minutes statement is comprised in the meeting text and is a subtitle statement that has a positional association with the target minutes statement, the meeting text comprises a plurality of subtitle statements, and the target minutes statement comprises a target meeting to-do statement.

22. The electronic device according to claim 20, wherein the processor is further configured to perform:
displaying the target minutes statement and the statement associated with the target minutes statement in a floating window in the meeting minutes display interface.

23. The method according to claim 8, wherein the target minutes statement comprises a target meeting to-do statement.
